(19) United States
(12) Patent Application Publication
(10) Pub. No.: US 2025/0314289 A1
(43) Pub. Date: Oct. 9, 2025

(54) LOGARITHMIC HOLLOW SHAFT SPEED REDUCER

(71) Applicants: Sorin Vasile Cora, Orange, CA (US); Judit Ildiko Dan, Orange, CA (US)

(72) Inventors: Sorin Vasile Cora, Orange, CA (US); Judit Ildiko Dan, Orange, CA (US)

(21) Appl. No.: 18/627,558

(22) Filed: Apr. 5, 2024

(51) Int. Cl. F16H 3/56; F01C 1/08

(52) U.S. Cl. CPC F16H 25/06; F01C 1/084; F16H 3/56; F16H 2025/063

(57) ABSTRACT

A logarithmic hollow shaft speed converter comprising a compact, modular two-stage rotary system with independently selectable coupling paths. The first stage produces coaxial outputs directed to either the ring, sun, or carrier of a standalone second-stage differential planetary gear. This architecture enables multiple torque-speed modes—high-speed/low-torque, balanced, and high-torque/low-speed—without altering drive element configuration. The converter's modularity and clarity support cost-effective manufacturing and flexible deployment.

### FIELD OF THE INVENTION

The present invention relates to a compact two-stage rotary speed conversion system. More specifically, it incorporates a hollow rotary speed converter with dual coaxial outputs as a first stage, operatively coupled to a standalone planetary gear set as a second stage. This integrated architecture provides an expanded range of transmission ratios and enhanced functional adaptability relative to conventional rotary speed converters.

### BACKGROUND OF THE INVENTION

Mechanical rotary speed converters play a vital role in power transmission systems by transferring torque and rotary motion from a power-generating subsystem (e.g., an electric motor) to a load-handling subsystem. Conventional converters typically rely on intermeshing rotary components (such as gears or splines), where the attainable transmission ratio is inherently limited by fixed geometric relationships.

A standalone planetary gear system-comprising a sun gear, planetary carrier, and ring gear-exhibits significant configurational flexibility, as any of the three components can function as the output, driven by the dynamic interplay of the other two. However, conventional implementations often compromise this versatility by statically fixing one component, thereby limiting the input-output configuration.

The embodiments presented hereafter address these limitations through a dual-stage mechanism that integrates a dual coaxial-output rotary speed converter with a standalone planetary gear assembly. This architecture enables finer control over a broader spectrum of transmission parameters while preserving a compact structural envelope, thus enhancing adaptability across a wide range of operational scenarios.

### SUMMARY OF THE INVENTION

The present invention provides a compact, dual-stage rotary speed conversion system designed to enhance both transmission versatility and spatial efficiency. The first stage includes a hollow rotary speed converter with dual coaxial outputs. The second stage comprises a standalone planetary gear assembly operatively coupled to the first stage, via sets of interconnecting components, enabling customizable output characteristics through selectable input to output routing. This integrated architecture expands the achievable transmission ratio range while maintaining a compact structural footprint, thereby improving adaptability across a wide spectrum of mechanical and electromechanical applications.

### BRIEF DESCRIPTION OF THE DRAWINGS

Having thus generally described the nature of the present invention, reference will now be made to the accompanying drawings, which illustrate, by way of example, one or more preferred embodiments thereof. It should be understood that the drawings are provided for illustrative purposes only and are not intended to limit the scope or spirit of the invention in any way. In the drawings, like reference characters designate corresponding parts in the various views:

FIG. 1 provides a high-level isometric and exploded cross-sectional view of the speed converter in accordance with the present invention, illustrating relative positions of the first and second stages. Interlocking components are omitted for clarity.

FIG. 1A provides a combined cross-sectional and exploded view of the first stage of the speed converter, with interlocking components omitted for clarity.

FIG. 1B provides a combined cross-sectional and exploded view of the second stage, likewise omitting interlocking components for clarity.

FIG. 2 illustrates the extended input component (10), showing its closed input groove (12) and its top interlocking interface (10a), as well as the closed output groove (21) of the output component (20).

FIG. 3 depicts the hollow fixed modulator (30), including its centrally arranged circular arrays of radial slots (31) and attachment holes (32), and incorporates diagram (3A), which defines the geometric condition required for smooth operation of the first stage of the speed converter.

FIG. 4 illustrates the spider-shaped interlocking components (210, 220, 230, and 240), configured to enable various coupling modalities between stages.

FIG. 5 presents cross-sectional views of three exemplary inter-stage coupling configurations (5A, 5B, and 5C) between the first and second stages, each featuring interlocking components that facilitate mechanical coupling.

FIG. 6 provides a high-level isometric and exploded cross-sectional view of an alternative embodiment of the speed converter in accordance with the present invention, illustrating the spatial relationship between the first and second stages. Interlocking components are omitted for clarity of illustration.

FIG. 6A provides a combined cross-sectional and exploded view of the modified first stage of the alternative embodiment of the speed converter, with interlocking components omitted for clarity.

FIG. 6B provides a combined cross-sectional and exploded view of the modified second stage of the alternative embodiment of the speed converter, with interlocking components omitted for clarity.

FIG. 7 illustrates the hollow input component (11), including its nested closed input grooves (12) and (14), and hollow output components (20) and (23), each incorporating respective closed output grooves (24) and (21).

FIG. 8 depicts the hollow fixed modulator (33), including its centrally arranged circular arrays of nested radial slots (34) and (35) and attachment holes (36), and includes diagram (8A), illustrating the geometric conditions required for smooth operation of the alternative first stage of the speed converter.

FIG. 9 illustrates the spider-shaped interlocking component (230), common to both embodiments) as well as components (250, 260, and 270), designed to facilitate various coupling modes between stages, in accordance with the alternative embodiment of the present invention.

FIG. 10 provides cross-sectional views of three exemplary inter-stage coupling configurations (10A, 10B, and 10C) between the first and second stages, each featuring interlocking components that facilitate mechanical coupling.

### DETAILED DESCRIPTION OF THE INVENTION

The terminology used herein is provided for illustrative purposes and is not intended to limit the invention to the particular embodiments described. As used herein, the term “and/or” encompasses any and all combinations of one or more of the associated listed items. The singular forms “a”, “an”, and “the” include plural referents unless the context explicitly indicates otherwise. It is further understood that the terms “comprises” and/or “comprising,” as used in the specification, denote the presence of stated features, elements, or components, but do not preclude the inclusion or addition of other features, elements, components, and/or groups thereof.

Unless otherwise specified, all terminology used herein shall be interpreted according to its ordinary meaning as understood by one skilled in the art relevant to this disclosure. For clarity and conciseness, not every permutation or configuration of the disclosed components is expressly detailed. Nonetheless, such variants, including modular subassemblies, scalable adaptations, and interface-compatible components, are encompassed within the scope of the invention.

This disclosure is illustrative and non-restrictive. Modifications, substitutions, and refinements—whether involving alternative geometries, material selections, dynamic interconnections, or application-specific tailoring—may be implemented without departing from the spirit or scope of the invention as defined by the appended claims. The figures and corresponding descriptions are not intended to limit the invention to the specific implementations shown but to enable understanding of the inventive principles, which may be adapted across diverse mechanical domains and usage environments.

Referring now to the appended figures, the present invention will be further described through illustrative embodiments. For the sake of clarity, bolts, nuts, and other fastening elements utilized in the assembly of the speed converter are omitted from the drawings.

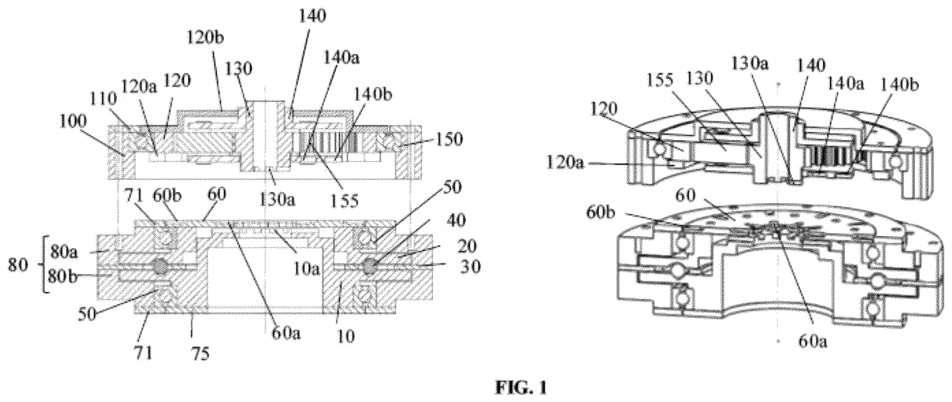

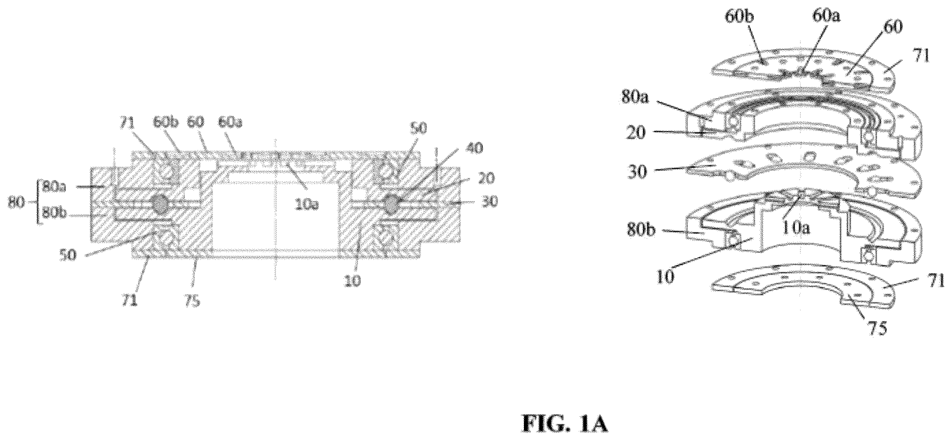

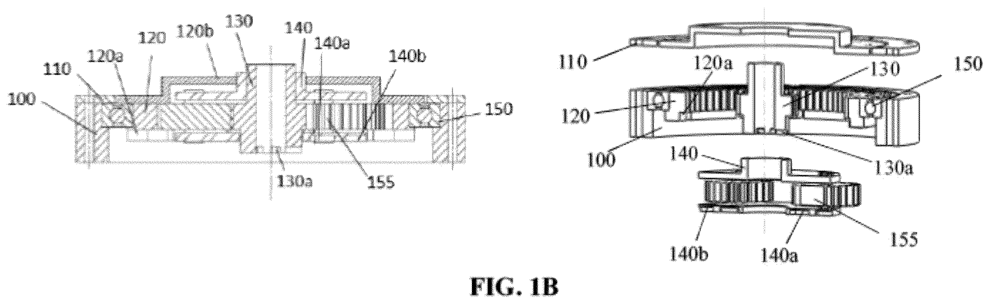

FIG. 1 illustrates the compact, two-stage rotary speed conversion system in both exploded and isometric cross-sectional views. The first stage includes a logarithmic hollow shaft speed converter featuring dual coaxial outputs. This stage is operatively coupled to a standalone planetary gear assembly. Mechanical interconnection between the two stages is enabled via spider-like coupling elements (not shown), each designed to maintain coaxial alignment and ensure smooth rotary motion and torque transmission.

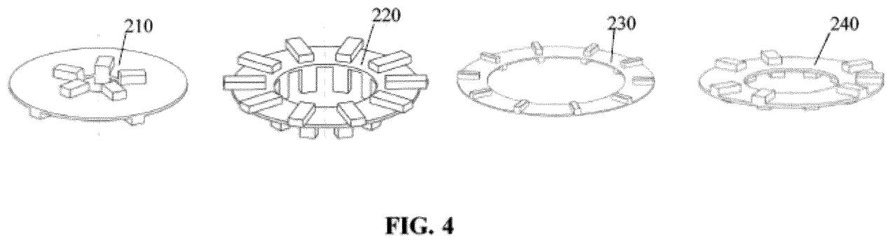

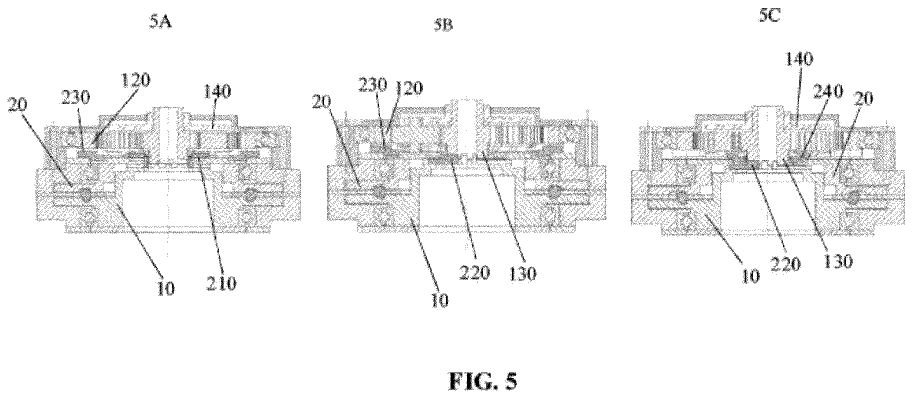

FIG. 1 further depicts the spatial arrangement of the two stages, with critical interlocking interfaces of the first stage designated as (10a), (60a), and (60b), and corresponding interlocking features of the second stage identified as (120a), (130a), (140a), and (140b). To facilitate visualization of the mechanical interface architecture, the spider-shaped coupling elements (210), (220), (230), and (240) are illustrated separately in FIG. 4, while their integration in assembled configurations (5A), (5B) and (5C) is shown in FIG. 5.

FIG. 1A provides the cross-section and an exploded view of the first stage, which comprises a logarithmic hollow shaft speed converter. This illustration highlights the relative positions of its primary components: an extended hollow driver component (10) featuring a locking interface (10a); a driven component (20) incorporating locking interfaces (60a) and (60b); a fixed hollow modulator (30); bearing balls (40) each seated within a corresponding radial slot (31) of modulator (30); positional ball bearings (50); and an outer body (80). The locking interfaces (60a) and (60b) are machined into the top surface of a hollow cover (60), which is fastened to the upper end of the driven component (20).

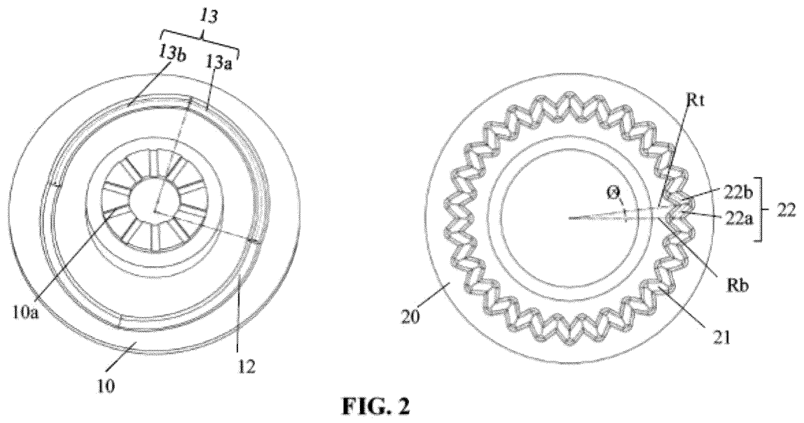

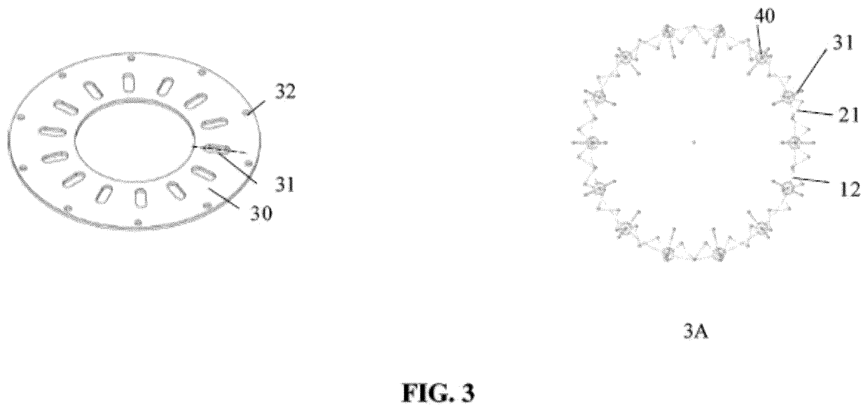

As shown in FIG. 3 and FIG. 1A, the bearing balls (40), are constrained to radial movement within the fixed modulator's slots (31), and function to transmit torque and rotary motion between the driver component (10) and driven component (20). Each ball simultaneously engages with the closed input groove (12) and the closed output groove (21) both detailed in FIG. 2. The closed input groove (12) comprises a centered circular array of lobes (13), each formed by two symmetrical arches (13a and 13b) about the radius passing through the apex of the ascending arch. Similarly, the output closed groove (21) is a centered circular array of lobes (22) defined by arches (22a and 22b) symmetrically arranged about the radius passing through the apex of its ascending arch.

The curvature and relative angular phasing of the input and output grooves are governed by logarithmic equations:

$$R = {R}_{b} * Log ( 1 + {K}_{12} * ∅ ) for groove ( 12 ) ;$$

$$R = {R}_{b} * Log ( 1 + {K}_{21} * ∅ ) for groove ( 21 ) ;$$

where R_{b} is the base radius, ø is the angular position, and K₁₂ and K₂₁ are non-dimensional constants associated with the input and output grooves, respectively. The transmission ratio of the first stage, defined by K₂₁/K₁₂, may be greater or less than unity.

As the driver component (10) rotates, the profile of its closed input groove (12) induces radial displacement of each bearing ball (40) along its corresponding modulator slot (31) in the fixed modulator (30), either inward or outward. This radial motion causes the ball to engage the closed output groove (21), thereby transmitting rotation to the closed output groove (21), and subsequently to driven component (20), in accordance with the instantaneous radial position of the bearing ball (40) as dictated by the rotating input groove. Smooth torque and rotary motion transmission is only feasible if, at any given instant, the centerlines of the closed input groove (12), closed output groove (21), slots (31), and the center point of each bearing ball (40) are precisely co-aligned, as illustrated in diagram 3A of FIG. 3.

FIG. 1B provides the cross-section and an exploded view of the second stage, which comprises a standalone planetary gear system. This illustration highlights the relative positions of its primary components: a ring gear (120) with interlocking interface (120a); a planetary carrier (140) with interlocking interfaces (140a) and (140b), machined on the lower carrier plate; a sun gear (130) with interlocking interface (130a); and a body (100), within which all components are coaxially aligned and rotatably mounted via a ball bearing (150).

The fully integrated configurations (5A, 5B, and 5C) of the speed converter of the present invention are depicted in FIG. 5.

In configuration 5A, the outer output (20) of the first stage is coupled via coupling component (230) to the ring gear (120) of the second stage, while the inner output (10) is connected through coupling element (210) to the planetary carrier (140) of the second stage. In this arrangement, the sun gear functions as the system's final output.

In configuration 5B, the planetary carrier serves as the system's final output. The first stage's outer output (20) remains connected to the second stage's ring gear (120) via coupling component (230), while the inner output (10) is connected to the second stage's sun gear (130) via coupling component (220).

In configuration 5C, the ring gear serves as the system's final output. The first stage's inner output (10) remains connected to the second stage's sun gear (130) via coupling component (220), while the outer output (20) is connected to the second stage's planetary carrier (140) via coupling component (240).

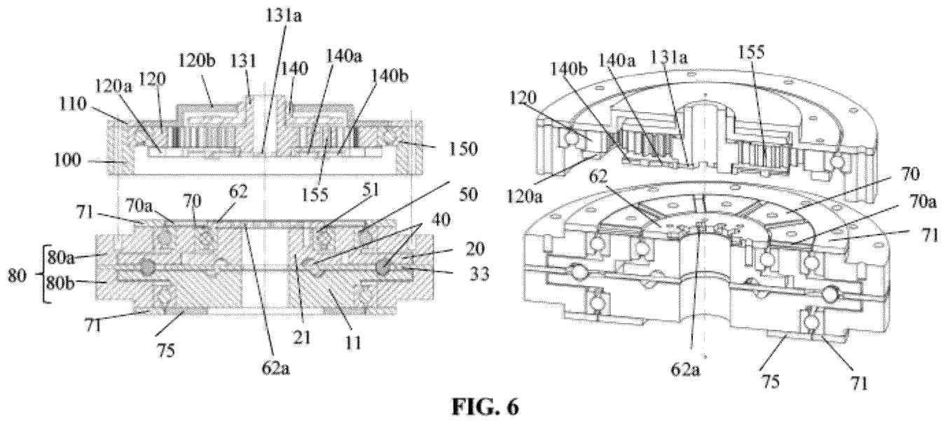

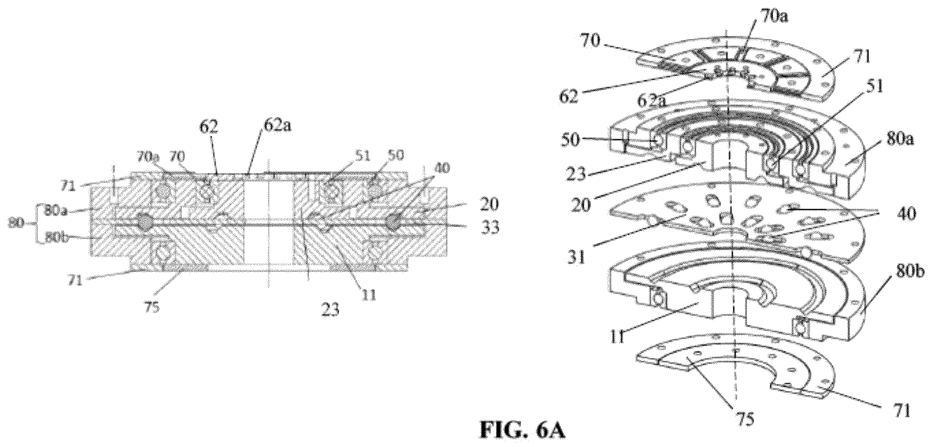

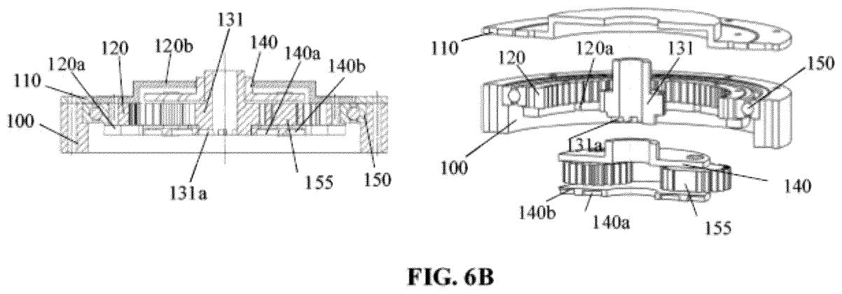

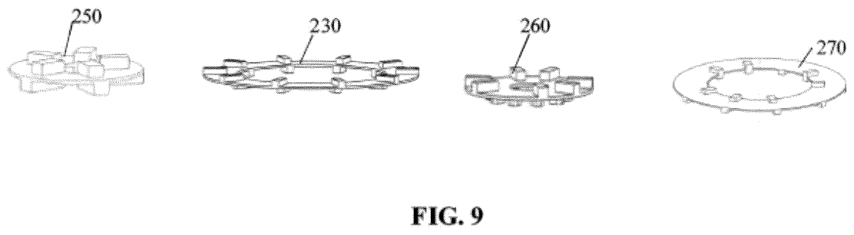

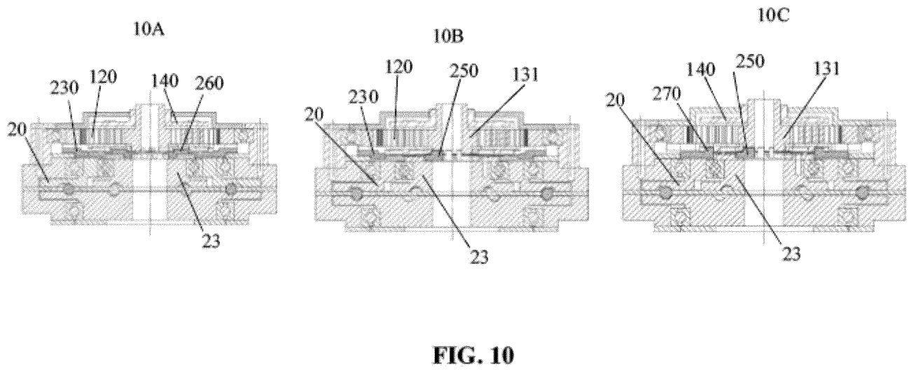

An alternative embodiment of the present invention is illustrated in FIG. 6, which shows a high-level configuration of a dual-stage rotary speed converter. The first stage comprises a logarithmic hollow shaft speed converter with a single input and dual coaxial outputs. This stage is operatively coupled to a second stage formed by a standalone planetary gear assembly. Coupling between the two stages is facilitated by a set of spider-like components (omitted from FIG. 6 for clarity), which are configured to interface with the interlocking features (70a) and (62a) of the first stage and the corresponding interlocking features (120a), (131a), (140a), and (140b) of the second stage. To enhance visualization of the mechanical interface architecture, the spider-like coupling elements (230), (250), (260), and (270) are depicted individually in FIG. 9, while their integration within the assembled system configurations (10A), (10B), and (10C) is illustrated in FIG. 10.

FIG. 6A presents the cross-section and an exploded view of the first stage of the logarithmic hollow shaft speed converter. Key components are shown in their relative alignment, including the hollow driver component (11); driven components—outer output (20) and inner output (23); the fixed hollow modulator (33); and bearing balls (40), each seated within corresponding radial slots (35) and (36) of the fixed modulator (33). Positional ball bearings (50) and (51) are also included, with all components coaxially assembled within the outer body (80). The interlocking interface (62a) is machined into the top surface of the hollow cover (62), which is bolted to the inner output (23), while the interlocking interface (70a) is machined into the top surface of the hollow cover (70), which is secured to the outer output (20) at its top end.

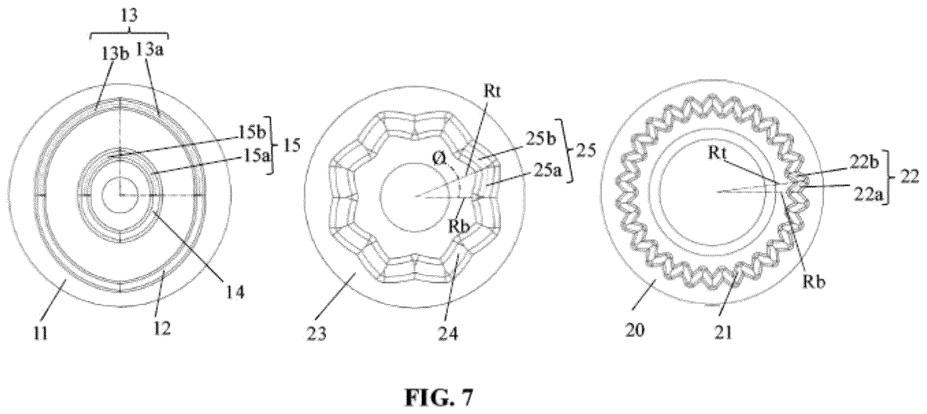

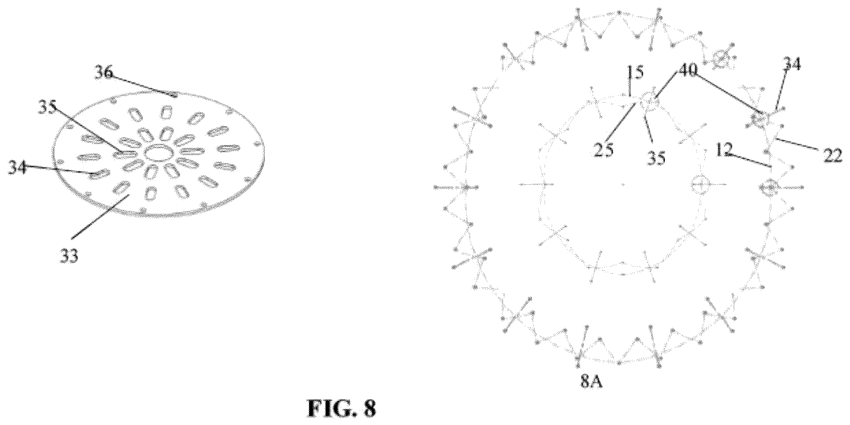

The bearing balls (40), constrained to radial movement within the fixed modulator's slots (34) and (35) (see FIGS. 8 and 6A), facilitate smooth torque transmission and rotary motion between the driver component (11) and the driven components (20) and (23). This is achieved by their simultaneous engagement with the closed input groove (12) and the closed output groove (21) for the outer output (20), as well as with the closed input groove (14) and the closed output groove (24) for the inner output (23). As detailed in FIG. 7, each closed grooves (12), (14), (21) and (24) comprises a centered circular array of identical lobes—(13), (15), (22) and (24), respectively—each lobe being defined by two arches symmetrically positioned about the radius passing through the apex of its ascending arch. FIG. 7 also illustrates, in comparison with FIG. 2, the primary distinction between the two embodiments of the present invention. In the first embodiment, the first stage operates with a single pair of input/output grooves—(12) and (21)—whereas in the second embodiment, the first stage simultaneously operates with an additional pair of input/output grooves (14) and (24).

The curvature and relative angular phasing of the input and output grooves are governed by logarithmic equations:

$$R = {R}_{b 1} * Log ( 1 + {K}_{12} * ∅ ) for groove ( 12 ) ;$$

$$R = {R}_{b 1} * Log ( 1 + {K}_{21} * ∅ ) for groove ( 21 ) ;$$

$$R = {R}_{b 2} * Log ( 1 + {K}_{14} * ∅ ) for groove ( 14 ) ;$$

$$R = {R}_{b 2} * Log ( 1 + {K}_{24} * ∅ ) for groove ( 24 ) ;$$

where R_{b1} and R_{b2} are the base radii, ø is the angular position, and K₁₂, K₂₁, K₁₄ and K₂₄ are non-dimensional constants associated with their respective grooves. These constants define a first transmission ratio K₂₁/K₁₂ for the outer output, and a second transmission ratio K₂₄/K₁₄ for the inner output of the first stage. Each ratio may be greater or less than unity.

A bearing ball (40), housed within a radial slot (34) of the fixed hollow modulator (33), simultaneously engages the closed input groove (12) and the closed output groove (21). As the driver component (11) rotates, the profile of its closed input groove (12) induces radial displacement of the bearing ball along its slot, driving it inward or outward. This radial motion brings the ball into engagement with the closed output groove (21), thereby transmitting torque and rotary motion to it, and subsequently to driven component (20), in accordance with the instantaneous radial position of the bearing ball (40) as governed by the rotating input groove component (12).

Similarly, the rotation of the driver component (11) causes the profile of its closed input groove (14) to induce radial displacement of each bearing ball (40) along its respective slot (35) in the fixed hollow modulator (33), again driving it inward or outward. This radial displacement brings the bearing ball into engagement with the output groove (24), thereby transmitting torque and rotary motion to it and subsequently to the driven component (23), in accordance with the instantaneous radial position of the bearing ball (40) as dictated by the rotating input groove (14).

Smooth torque and rotary motion transmission is feasible only when, at any given instant, there is precise and simultaneous co-alignment of all interacting components—namely, the closed grooves, radial slots, and bearing balls—as shown in diagram (8A) of FIG. 8.

FIG. 6B provides the cross-section and an exploded view of the second stage of the second embodiment of the present invention, which comprises a standalone planetary gear system. This second stage is identical to that of the previous embodiment, with the exception of the sun gear (131), whose interlocking interface (131a) differs slightly in dimensions from the interface (130a) of the sun gear (130) in the previous embodiment.

The fully integrated configurations (10A, 10B, and 10C) of the speed converter according to the second embodiment of the present invention are illustrated in FIG. 10.

In configuration 10A, the outer output (20) of the first stage is coupled via coupling component (230) to the ring gear (120) of the second stage, while the inner output (23) is connected through coupling element (260) to the planetary carrier 140 of the second stage. In this arrangement, the sun gear functions as the system's final output. This configuration delivers a high-speed, low-torque output, with the final output rotating in the same direction as the ring gear and planetary carrier inputs. It is particularly well-suited for applications emphasizing rapid actuation or rotational responsiveness.

In configuration 10B, the planetary carrier serves as the system's final output. The first stage's outer output (20) remains connected to the ring gear (120) of the second stage via coupling component (230), while the inner output (23) is connected to the sun gear (131) via coupling component (250). This arrangement yields a moderate output speed and torque, with the final output rotation typically aligning with the net rotational bias of the first stage. It offers a balanced trade-off between torque capacity and response time, beneficial for load-adaptive mechanisms.

In configuration 10C, the ring gear serves as the final output. The first stage's inner output (23) is connected to the sun gear (131) of the second stage via coupling component (250), while the outer output (20) is coupled to the planetary carrier (140) via coupling component (270). This configuration provides a high-torque, low-speed output, with the final output typically rotating in the opposite direction of the sun gear drive. It is ideal for torque-intensive applications such as lifting, indexing, or force amplification systems.

The embodiments of the invention in which an exclusive property or privilege is claimed are defined as follow:
1 A speed converter system comprising: a first-stage coaxial dual-output module including a hollow, rotatable driver component configured to rotate about a central axis and extend coaxially through a fixed hollow modulator disc and a coaxial hollow driven component, the driver component functioning as an inner output of the first stage and having a flanged configuration with a closed input groove formed in an upper surface of the flange and an interlocking interface on a top face, the interlocking interface including one or more radial grooves or dowel pin holes; a hollow driven component functioning as an outer output of the first stage and rotatable about the central axis, the driven component having a closed output groove on one surface and an interlocking interface on an opposite surface; a fixed hollow modulator disc positioned between the driver and driven components, the modulator disc including a centered circular array of radial slots and an array of attachment holes; a housing body including positioning ball bearings securing the modulator disc and coaxially aligning the input and output components such that their respective closed grooves face one another; a plurality of bearing balls, each disposed in a corresponding radial slot of the modulator disc and positioned between the input and output grooves, the bearing balls being constrained to move radially along the slots in response to rotation of the driver component to transmit torque to the driven component; a second-stage standalone planetary gear set including a sun gear having a machined interlocking interface configured to couple with the inner output of the first stage via a coupling component; a satellite carrier including a lower plate with two concentric machined interlocking interfaces selectively couplable with either coaxial output of the first stage via corresponding interlocking components; and a ring gear having a machined interlocking interface configured to couple with the outer output of the first stage via a coupling component; a second-stage housing body including a positional ball bearing that encloses the sun gear, the satellite carrier, and the ring gear in a coaxial arrangement; and a plurality of interlocking connectors including at least one of dowel pins or spider-shaped components configured to enable mechanical engagement between the coaxial outputs of the first stage and the components of the second-stage planetary gear set.
2. The speed converter system of claim 1, wherein the closed input groove comprises a centered circular array of identical lobes, each lobe formed by two symmetrical arches mirrored about a radius passing through a lobe apex, a centerline of each arch being defined by the logarithmic function F(ϕ)=Rb·log(10+K₁·ϕ), and wherein the closed output groove comprises a centered circular array of identical lobes differing in number from the lobes of the input groove, each lobe formed by two symmetrical arches mirrored about a radius passing through a lobe apex, a centerline of each arch being defined by the logarithmic function F(ϕ)=Rb·log(10+K₂·ϕ), where Rb is the radius at the innermost vertex of the arch, ϕ is the subtended angle at the center, and the ratio K₂/K₁ defines a transmission ratio of the first stage.
3. The speed converter system of claims 1 and 2, wherein the interlocking interface of the hollow driven component is machined on a hollow disc affixed to an end surface thereof.
4. The speed converter system of any one of claims 1 through 3, wherein the second-stage components are coupled with the first-stage outputs in one of the following mutually exclusive configurations: (i) the sun gear functions as a main output of the speed converter, the second-stage carrier being connected to the inner output of the first stage, and the ring gear being connected to the outer output of the first stage via corresponding interlocking components; (ii) the carrier functions as the main output of the speed converter, the second-stage sun gear being connected to the inner output of the first stage, and the ring gear being connected to the outer output of the first stage via corresponding interlocking components; or (iii) the ring gear functions as the main output of the speed converter, the second-stage carrier being connected to the outer output of the first stage, and the sun gear being connected to the inner output of the first stage via corresponding interlocking components.
5. A speed converter system comprising: a first-stage coaxial dual-output module including a hollow driver component that is rotatable about a central axis, the driver component having two concentric closed input grooves on one surface and an interlocking interface including one or more radial grooves or dowel pin holes machined on an opposite face; a first hollow driven component functioning as an inner output of the first stage and rotatable about the central axis, the driven component having a closed output groove on one surface and an interlocking interface on an opposite surface; a second hollow driven component coaxial with the first and functioning as an outer output of the first stage and rotatable about the central axis, the second driven component having a closed output groove on one surface and an interlocking interface on an opposite surface; a fixed hollow modulator disc positioned between the driver component and the driven components, the modulator disc comprising two concentrically nested circular arrays of radial slots and a centered circular array of attachment holes; a housing body including positioning ball bearings securing the modulator disc and coaxially aligning the input and output components such that their respective closed grooves face one another; a plurality of bearing balls, each disposed in a corresponding radial slot and positioned between the input and output grooves, the bearing balls being constrained to move radially along the slots in response to rotation of the driver component to transmit torque to the driven components; a second-stage standalone planetary gear set including a sun gear having a machined interlocking interface adapted to engage with the inner output of the first stage via a coupling component, a satellite carrier having a lower plate with two concentric machined interlocking interfaces selectively couplable with either coaxial output of the first stage via corresponding interlocking components, and a ring gear having a machined interlocking interface configured to couple with the outer output of the first stage; a second-stage housing body including a positional ball bearing enclosing the sun gear, the satellite carrier, and the ring gear in a coaxial arrangement; and a plurality of interlocking connectors including at least one of dowel pins or spider-shaped components configured to enable mechanical engagement between the coaxial outputs of the first stage and components of the second-stage planetary gear set.
6. The speed converter system of claim 5, wherein: (i) the inner closed input groove comprises a centered circular array of identical lobes, each lobe comprising two symmetrical arches mirrored about a radius intersecting the lobe apex, a centerline of each arch being defined by F(ϕ)=Rb·log(10+K₁·ϕ); (ii) the inner closed output groove comprises a centered circular array of identical lobes having a lobe count differing from that of the inner input groove, each lobe comprising two symmetrical arches with centerlines defined by F(ϕ)=Rb·log(10+K₂·ϕ); (iii) the outer closed input groove comprises a centered circular array of identical lobes with centerlines defined by F(ϕ)=Rb·log(10+K₃·ϕ); and (iv) the outer closed output groove comprises a centered circular array of identical lobes differing in number from the outer input groove, with centerlines defined by F(ϕ)=Rb·log(10+K₄·ϕ), where R_{b} denotes a radial distance to the innermost vertex of each arch, ϕ is a subtended angle measured at the groove center, and the transmission ratios are defined respectively by K₂/K₁ and K₄/K₃.
7. The speed converter system of claim 6, wherein the interlocking interfaces of the hollow driven components are machined on hollow discs affixed to respective grooveless axial end surfaces of the first-stage outputs.
8. The speed converter system of any one of claims 5 through 7, wherein the second-stage components are coupled with the first-stage outputs in one of the following mutually exclusive configurations: (i) the sun gear functions as a main output of the speed converter, the second-stage carrier being connected to the inner output of the first stage, and the ring gear being connected to the outer output of the first stage via corresponding interlocking components; (ii) the carrier functions as the main output, the second-stage sun gear being connected to the inner output of the first stage, and the ring gear being connected to the outer output via corresponding interlocking components; or (iii) the ring gear functions as the main output, the second-stage carrier being connected to the outer output of the first stage, and the sun gear being connected to the inner output via corresponding interlocking components.
9. The speed converter system of claim 2 or claim 6, wherein the input groove centerline is defined by F(ϕ)=Rb·(1+K₁·ϕ), and the output groove centerline is defined by F(ϕ)=Rb·(1+K₂·ϕ), where Rb denotes a radius at an innermost point of the centerline, ϕ is a subtended angle, and K₁ and K₂ are real numbers with the ratio K₂/K₁ defining a transmission ratio.
10. The speed converter system of claim 2 or claim 6, wherein the input groove centerline is defined by the exponential function F(ϕ)=Rb·A\hat{ }(K₁·ϕ), and the output groove centerline is defined by F(ϕ)=Rb·A\hat{ }(K₂·ϕ), where Rb denotes a radius at an innermost point of the centerline, ϕ is a subtended angle, and K₁ and K₂ are real numbers with the ratio K₂/K₁ defining a transmission ratio.

1. A speed converter system comprising: a first-stage coaxial dual-output module including a hollow, rotatable driver component configured to rotate about a central axis and extend coaxially through a fixed hollow modulator disc and a coaxial hollow driven component, the driver component functioning as an inner output of the first stage and having a flanged configuration with a closed input groove formed in an upper surface of the flange and an interlocking interface on a top face, the interlocking interface including one or more radial grooves or dowel pin holes; a hollow driven component functioning as an outer output of the first stage and rotatable about the central axis, the driven component having a closed output groove on one surface and an interlocking interface on an opposite surface; a fixed hollow modulator disc positioned between the driver and driven components, the modulator disc including a centered circular array of radial slots and an array of attachment holes; a housing body including positioning ball bearings securing the modulator disc and coaxially aligning the input and output components such that their respective closed grooves face one another; a plurality of bearing balls, each disposed in a corresponding radial slot of the modulator disc and positioned between the input and output grooves, the bearing balls being constrained to move radially along the slots in response to rotation of the driver component to transmit torque to the driven component; a second-stage standalone planetary gear set including a sun gear having a machined interlocking interface configured to couple with the inner output of the first stage via a coupling component; a satellite carrier including a lower plate with two concentric machined interlocking interfaces selectively couplable with either coaxial output of the first stage via corresponding interlocking components; and a ring gear having a machined interlocking interface configured to couple with the outer output of the first stage via a coupling component; a second-stage housing body including a positional ball bearing that encloses the sun gear, the satellite carrier, and the ring gear in a coaxial arrangement; and a plurality of interlocking connectors including at least one of dowel pins or spider-shaped components configured to enable mechanical engagement between the coaxial outputs of the first stage and the components of the second-stage planetary gear set.

2. The speed converter system of claim 1, wherein the closed input groove comprises a centered circular array of identical lobes, each lobe formed by two symmetrical arches mirrored about a radius passing through a lobe apex, a centerline of each arch being defined by the logarithmic function F(ϕ)=Rb·log(10+K₁·ϕ), and wherein the closed output groove comprises a centered circular array of identical lobes differing in number from the lobes of the input groove, each lobe formed by two symmetrical arches mirrored about a radius passing through a lobe apex, a centerline of each arch being defined by the logarithmic function F(ϕ)=Rb·log(10+K₂·ϕ), where Rb is the radius at the innermost vertex of the arch, ϕ is the subtended angle at the center, and the ratio K₂/K₁ defines a transmission ratio of the first stage.

3. The speed converter system of claims 1 and 2, wherein the interlocking interface of the hollow driven component is machined on a hollow disc affixed to an end surface thereof.

4. The speed converter system of any one of claims 1 through 3, wherein the second-stage components are coupled with the first-stage outputs in one of the following mutually exclusive configurations: (i) the sun gear functions as a main output of the speed converter, the second-stage carrier being connected to the inner output of the first stage, and the ring gear being connected to the outer output of the first stage via corresponding interlocking components; (ii) the carrier functions as the main output of the speed converter, the second-stage sun gear being connected to the inner output of the first stage, and the ring gear being connected to the outer output of the first stage via corresponding interlocking components; or (iii) the ring gear functions as the main output of the speed converter, the second-stage carrier being connected to the outer output of the first stage, and the sun gear being connected to the inner output of the first stage via corresponding interlocking components.

5. A speed converter system comprising: a first-stage coaxial dual-output module including a hollow driver component that is rotatable about a central axis, the driver component having two concentric closed input grooves on one surface and an interlocking interface including one or more radial grooves or dowel pin holes machined on an opposite face; a first hollow driven component functioning as an inner output of the first stage and rotatable about the central axis, the driven component having a closed output groove on one surface and an interlocking interface on an opposite surface; a second hollow driven component coaxial with the first and functioning as an outer output of the first stage and rotatable about the central axis, the second driven component having a closed output groove on one surface and an interlocking interface on an opposite surface; a fixed hollow modulator disc positioned between the driver component and the driven components, the modulator disc comprising two concentrically nested circular arrays of radial slots and a centered circular array of attachment holes; a housing body including positioning ball bearings securing the modulator disc and coaxially aligning the input and output components such that their respective closed grooves face one another; a plurality of bearing balls, each disposed in a corresponding radial slot and positioned between the input and output grooves, the bearing balls being constrained to move radially along the slots in response to rotation of the driver component to transmit torque to the driven components; a second-stage standalone planetary gear set including a sun gear having a machined interlocking interface adapted to engage with the inner output of the first stage via a coupling component, a satellite carrier having a lower plate with two concentric machined interlocking interfaces selectively couplable with either coaxial output of the first stage via corresponding interlocking components, and a ring gear having a machined interlocking interface configured to couple with the outer output of the first stage; a second-stage housing body including a positional ball bearing enclosing the sun gear, the satellite carrier, and the ring gear in a coaxial arrangement; and a plurality of interlocking connectors including at least one of dowel pins or spider-shaped components configured to enable mechanical engagement between the coaxial outputs of the first stage and components of the second-stage planetary gear set.

6. The speed converter system of claim 5, wherein: (i) the inner closed input groove comprises a centered circular array of identical lobes, each lobe comprising two symmetrical arches mirrored about a radius intersecting the lobe apex, a centerline of each arch being defined by F(ϕ)=Rb·log(10+K₁·ϕ); (ii) the inner closed output groove comprises a centered circular array of identical lobes having a lobe count differing from that of the inner input groove, each lobe comprising two symmetrical arches with centerlines defined by F(ϕ)=Rb·log(10+K₂·ϕ); (iii) the outer closed input groove comprises a centered circular array of identical lobes with centerlines defined by F(ϕ)=Rb·log(10+K₃·ϕ); and (iv) the outer closed output groove comprises a centered circular array of identical lobes differing in number from the outer input groove, with centerlines defined by F(ϕ)=Rb·log(10+K₄·ϕ), where Rb denotes a radial distance to the innermost vertex of each arch, ϕ is a subtended angle measured at the groove center, and the transmission ratios are defined respectively by K₂/K₁ and K₄/K₃.

7. The speed converter system of claim 6, wherein the interlocking interfaces of the hollow driven components are machined on hollow discs affixed to respective grooveless axial end surfaces of the first-stage outputs.

8. The speed converter system of any one of claims 5 through 7, wherein the second-stage components are coupled with the first-stage outputs in one of the following mutually exclusive configurations: (i) the sun gear functions as a main output of the speed converter, the second-stage carrier being connected to the inner output of the first stage, and the ring gear being connected to the outer output of the first stage via corresponding interlocking components; (ii) the carrier functions as the main output, the second-stage sun gear being connected to the inner output of the first stage, and the ring gear being connected to the outer output via corresponding interlocking components; or (iii) the ring gear functions as the main output, the second-stage carrier being connected to the outer output of the first stage, and the sun gear being connected to the inner output via corresponding interlocking components.

9. The speed converter system of claim 2 or claim 6, wherein the input groove centerline is defined by F(ϕ)=Rb·(1+K₁·ϕ), and the output groove centerline is defined by F(ϕ)=Rb·(1+K₂·ϕ), where Rb denotes a radius at an innermost point of the centerline, ϕ is a subtended angle, and K₁ and K₂ are real numbers with the ratio K₂/K₁ defining a transmission ratio.

10. The speed converter system of claim 2 or claim 6, wherein the input groove centerline is defined by the exponential function F(ϕ)=Rb·A\hat{ }(K₁·ϕ), and the output groove centerline is defined by F(ϕ)=Rb·A\hat{ }(K₂·ϕ), where Rb denotes a radius at an innermost point of the centerline, ϕ is a subtended angle, and K₁ and K₂ are real numbers with the ratio K₂/K₁ defining a transmission ratio.
